(19) United States
(12) Patent Application Publication
(10) Pub. No.: US 2002/0161694 A1
(43) Pub. Date: Oct. 31, 2002

(54) Electronic business using a broker web site in the internet to negotiate transactions between inquirer and answer provider

(76) Inventor: Kung Shao Yuan, Taipei (TW)

Correspondence Address: Keith Kline, PRO-TECHTOR INTERNATIONAL SERVICES, 20775 Norada Court, Saratoga, CA, 95070-3018, US

(21) Appl. No.: 09/846,529

(22) Filed: Apr. 30, 2001

(51) Int. Cl. G06F 17/60

(52) U.S. Cl. 705/37

(57) ABSTRACT

An electronic business mode of using a broker web site in the Internet to negotiate transactions between an inquirer and an answer provider, the broker web side comprising a data bank providing the services of: (i) opening for the registration of potential answer providers in different technical fields and classifying registered members of potential answer provider subject to their specialty, (ii) accepting questions issued by inquirers, (iii) transferring the questions issued by inquirers to members of potential answer provider, (iv) accepting information from the members of potential answer provider regarding the answer, the abstract of answer, the cost of providing the answer, (v) transferring the information of abstract of answer and cost of providing the answer from the members of potential answer provider to the inquirer, (vi) transferring the answer to the inquirer and completing the transaction, (vii) negotiating transaction under anonymous mode, (viii) communicating each other indirectly between the inquirer and the answer provider, and (ix) disclosing identification of either party or the method of communication.

### BACKGROUND OF THE INVENTION

1. Field of the Invention

The present invention relates to an electronic business mode of using a broker web site in the Internet to negotiate transactions between an inquirer and an answer provider. The running of the electronic business mode is achieved by means of controlling the broker web site to receive questions from an inquirer or inquirers entering the broker web site and messages from answer providers capable of answering the questions, enabling messages to be exchanged between the inquirer(s) and the answer providers without letting the answer providers contact the inquirer(s) directly. The broker web site does not disclose the identification of either side or the method of communication. However, either the inquirer or the answer provider has the choice of disclosing one's identification or the method of communication.

2. Description of the Prior Art

It has become a part of our daily life to collect information, order consumer products, or watch programs through the Internet. There are several methods of searching an answer to a particular question through the Internet. These methods are outlined hereinafter:

1. Browsing: entering the related web site to browse its web pages.

2. Search engine: using a search engine to search web sites concerned by keying-in key words, and then entering the searched web sites to browse their web pages. Some search engines are capable of recognizing the key word of a whole sentence and then lifting the related web sites or information. Some other search engines are capable for executing full sentence indexing. There are particular web sites providing a catalog searching service. These catalog searching service providing web sites use similar technique of search engines.

3. BBS (Bulletin board system): entering a particular web site, and then posting the question on the BBS of the web site to ask for an answer.

4. Discussion: entering the discussion zone of a particular web site to exchange ideas and discuss questions freely with members entering the web site.

5. Virtual community: using a virtual community to exchange information by means of any of a variety of communication methods including browsing, chat line, E-mail, personal web page, and etc.

6. Direct communication: If the inquirer knows the way of contacting the answer provider, the inquirer can directly inquire the answer provider for the answer

At present time, electronic business mode of negotiating transactions between the inquirer and the respondent using the Internet is not available. When connecting to the Internet to find the answer for a particular question, one shall have to spend much time in browsing web pages or search engines to find potential respondents capable of giving the answer. When inquiring a BBS, the discussion zone of a web site, or a virtual community for the answer to a particular question, potential respondents may not be willing to give the answer due to the reason of servicing without payment, being afraid of exposing one's identification or the method of communication, possibility of receiving abundant garbage mails or disturbing. These problems also hinder people from inquiring the answer for a particular question through the Internet.

### SUMMARY OF THE INVENTION

The present invention has been accomplished to provide an electronic business mode of using the Internet to negotiate transactions between the inquirer and the respondent, which eliminates the aforesaid problems. The invention includes three skills:

1. Opening for registration of potential answer providers and transferring question to multiple potential answer providers: Any individual, company, organization, or web site is allowed to log in and to become members of potential answer provider in particular fields. The broker web site classifies registered members of potential answer provider subject to their specialty. When one inputted the question and clicked the technical field concerned after entered the broker web site, the broker web site immediately transfers the question to the registered members of potential answer provider specialized in the technical field concerned and asks them to provide the inquirer with the answer. This action extends the answer-providing source for the inquirer so as to increase the chance of getting the answer and to save the inquirer's time in searching for the answer.

2. Isolating the inquirer and the answer providers: All the questions, answers and messages concerned are transferred between the inquirers and the members of potential answer provider through the broker web site. The broker web site does not disclosure the identification of either party or the method of communication without the permission of the respective party. However, either or both parties can select the way of contact by “anonymous” or by “real name”. Under the way of contact by anonymous through the broker web site, the identification of either party is kept in secret and not exposed to the opposite party. This security measure greatly increases the willing of people to participate the transaction.

3. Providing a cost negotiation and business transaction system under isolation status: When negotiation transactions between the inquirer and the answer provider under anonymous mode, a cost negotiation and business transaction system must be provided. This mode provides the system, keeping the system run through the broker web site.

### BRIEF DESCRIPTION OF THE DRAWINGS

FIG. 1 is a block diagram showing the transaction between the inquirer and the answer provider through the broker web site.

### DETAILED DESCRIPTION OF THE PREFERRED EMBODIMENT

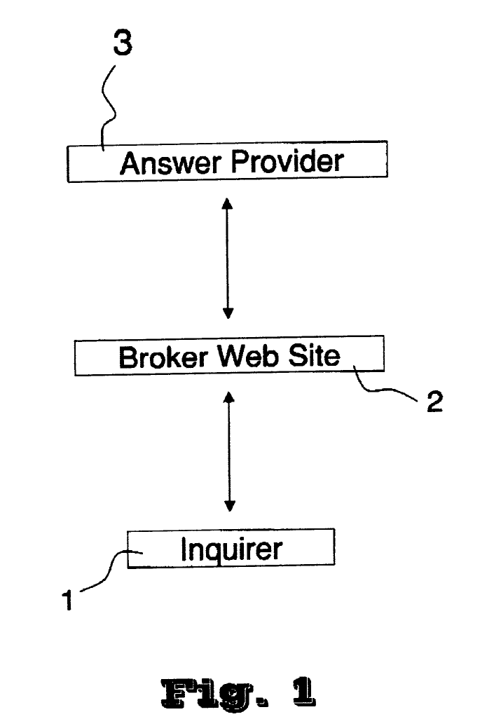

Referring to FIG. 1, the electronic business mode of using the Internet to negotiate transactions between the inquirer and the answer provider in accordance with the present invention is to establish a broker web site 2 in the Internet, enabling the broker web site 2 to negotiate transactions between the inquirer 1 and the answer provider 3. The broker web site 2 provides a data bank, which provides the services of: (i) opening for the registration of potential answer providers in different technical fields and classifying registered members of potential answer provider subject to their specialty, (ii) accepting questions issued by inquirers, (iii) transferring the questions issued by inquirers to members of potential answer provider, (iv) accepting information from the members of potential answer provider regarding the answer, the abstract of answer, the cost of providing the answer, (v) transferring the information of abstract of answer and cost of providing the answer from the members of potential answer provider to the inquirer, (vi) transferring the answer to the inquirer and completing the transaction, (vii) negotiating transaction under anonymous mode, (viii) communicating each other indirectly between the inquirer and the answer provider, and (ix) disclosing identification of either party or the method of communication. Through the services of the data bank of the broker web site, the inquirer 1 issues the question to the broker web site 2, and the members of potential answer provider 3 provide the answer to the inquirer 1.

The detailed operation procedure of the present invention is outlined hereinafter.

(I) Open for the Registration of Potential Answer Providers in Different Technical Fields and Classify Registered Members of Potential Answer Provider Subject to Their Specialty:

Any individual, company, organization, or web site can enter the broker web site 2 and input the respective E-mail address or the method of communication (including personal web page, chat call ICQ, or any of a variety of contact methods available in the Internet) and field of specialty to become a member of potential answer provider 3 of the broker web site 2. A potential answer provider 3 can select to negotiate transaction under anonymous mode or with the real name. When clicking the transaction mode with the real name, the potential answer provider 3 must input the name and personal information, letting the personal information to be shown on the web page of the broker web site 2. When clicking the anonymous transaction mode, the potential answer provider 3 does not need to input the name and personal information except one's filed of specialty, and the identification or method of communication of the potential answer provider 3 will never be disclosed in the broker web site 2.

(II) Accept Questions Issued by Inquirers:

Any individual, company, organization, or web site wishing to search the answer for a particular question can enter the broker web site 2, and then input one's e-mail address or method of communication (including personal web page, chat call ICQ, or any of a variety of contact methods available in the Internet) and the information about the question, and then click the field of specialty to which the question issued pertains. The inquirer can decide to negotiate the transaction under anonymous mode or with the real name. When clicking the transaction mode with the real name, the inquirer 2 must attach the name and personal information to the inputted question. When clicking the anonymous transaction mode, the inquirer 2 does not need to input the name and personal information when inputting the question, and the identification or method of communication of the inquirer 2 will never be disclosed in the broker web site 2. The broker web site 2 codes every inputted question a particular code number, and gives the code number to the inquirer who issued the question by means of publishing the information on the web page, sending the information by e-mail, chat call ICQ, or any of a variety of contact methods available in the Internet. Because an inquirer may issue two or more questions, it is necessary to code every question with a particular code number. Further, the inquirer 1 can directly contact the potential answer providers 3 who registered the transaction mode with the real name.

(III) Transfer the Questions Issued by Inquirers to Members of Potential Answer Provider:

Upon receipt of questions issued by inquirers, the broker web site 2 transfers the questions and the respective code number to the potential answer providers 3 of the field of specialty concerned (several potential answer providers 3 may simultaneously receive the questions) to ask for the answer. The so-called “transfer” means that the broker web site 2 writes the message into a message passenger upon receipt of it. The message passenger can be a web page of the broker web site 2, e-mail, chat call ICQ, or any of a variety of communication methods available in the Internet. Because any party (potential answer provider) receiving the message cannot trace back the delivery path of the message, no one can know the identification of the inquirer who issued the message unless the inquirer agreed to disclose one's identification or method of communication.

(IV) Accept Information From the Members of Potential Answer Provider Regarding the Answer, the Abstract of Answer, the Cost of Providing the Answer:

Abstract of answer is provided by the answer provider in either of the following four ways or a combination of them:

1. The content of the answer without the key point;

2. A part of the answer without the key point;

3. Resume of the answer provider;

4. Any information that invites the inquirer to by the answer from the answer provider without revealing the key point of the answer.

Upon receipt of the information of the question and its code number from the broker web site 2, every answer provider can decide if to answer the question or not. In case one answer provider agrees to answer the question and wishes to sell the answer at a particular price (the price can be zero), the answer provider 3 can enter the broker web site 2 and input the code number of the question, the answer, the abstract of answer, and the cost for answering the question. The answer provider 3 can decide not to input the answer into the broker web site 2 before the transaction is done. The broker web site 2 gives a particular code number of the answer for a particular question, and then informs the inquirer with the code number of the answer by means of the web page of the broker web site, e-mail, chat call ICQ, or any of a variety of communication methods available in the Internet. Because two or more different answers may be available to a particular question, it is necessary to code different answers with different code numbers for identification. Further, the answer provider 3 can directly contact the inquirer 1 without through the broker web site 2 if the inquirer agreed to disclose one's identification information or method of communication.

(V) Transfer the Information of Abstract of Answer and Cost of Providing the Answer From the Members of Potential Answer Provider to the Inquirer:

Upon receipt of information about the code number of question, answer, abstract of answer, cost of providing the answer, etc. from the answer provider 3, the broker web site 2 holds the answer at first, and then transfers the information of the code number of question, code number of answer, answer, abstract of answer, cost of providing the answer, etc. to the inquirer 1 (because the code number of question is a particular code, the broker web site 2 can quickly find out the identification of the inquirer 1 and immediately send the information concerned to the inquirer 1). The action of holding the answer when transferring the information of the code number of question, code number of answer, answer, abstract of answer, cost of providing the answer, etc. to the inquirer is to protect the interest of the answer provider 3 and to promote the sale of the answer. If the broker web site 2 transfers the answer to the inquirer 1 with the other information concerned, the inquirer 1 may not agree to pay the money after obtained the answer. Further, if the broker web site 2 does not transfer the abstract of answer to the inquirer 1, the inquirer 1 dares not to pay the money without knowing the quality of the answer or the identification of the answer provider. If the cost of providing the answer is zero, it means that the answer provider agrees to provide a free service, and the broker web site 2 will directly transfer the answer to the inquirer 1. Further, if either party has disclosed one's identification or the method of communication, both parties can negotiate the transaction subject to the aforesaid procedure through the broker web site 2, or directly contact the opposite party without through the broker web site 2.

(VI) Transfer the Answer to the Inquirer and Complete the Transaction:

If it is worthy to buy the answer from the answer provider 3 at the indicated cost, the inquirer 1 can enter the broker web site 2 and input the code number of answer corresponding to the issued question and pay the money to the broker web site 2. Upon receipt of the payment from the inquirer 1, the broker web site 2 immediately transfers the answer to the inquirer 1 and the payment to the answer provider 3 (because the code number of answer is a particular code, the broker web site 2 can correctly transfer the payment to the right answer provider 3). If the answer provider 3 simply inputted the information of code number of question, abstract of answer, and cost of providing the answer into the broker web site 2, the broker web site 2 will ask the answer provider 3 to input the answer and then transfer the answer to the inquirer 1 before transferring the payment to the answer provider 3. If a down payment system is adopted, the broker web site 2 will transfer the answer to the inquirer 1 and the down payment to the answer provider after receipt of the down payment from the inquirer 1, and then transfer the balance to the answer provider 3 upon receipt of the same from the inquirer 1. If the answer provider 3 didn't input the answer into the broker web site 2 in the aforesaid steps 15, the broker web site 2 will ask the answer provider 3 to provide the answer after receipt of the payment or down payment from the inquirer 1, and then transfer the answer to the inquirer 1. During a transaction, the tax is deducted from the payment, if any. If either party has disclosed one's identification or the method of communication, both parties can negotiate the transaction subject to the aforesaid procedure through the broker web site 2, or directly contact the opposite party without through the broker web site 2.

(VII) Negotiate Transaction Under Anonymous Mode:

When both the inquirer 1 and the answer provider 3 selected anonymous transaction mode, the inquirer 1 can enter the broker web site 2 and input the message of the code number of answer and the expected price of obtaining the answer into the broker web site 2 after received the message of the code number of question, the code number of answer, the abstract of answer and the cost of providing the answer transferred by the broker web site 2, and the broker web site 2 will immediately transfer the message inputted by the inquirer 1 to the answer provider 3. Upon receipt of the message transferred from the broker web site 2, the answer provider 3 can enter the broker web site 2 and input the code number of answer and the expected cost of providing the answer. The broker web site 2 will soon transfer the message inputted by the answer provider 3 to the inquirer 1. Both the inquirer 1 and the answer provider 3 can repeatedly enter the broker web site 2 to negotiate the transaction by means of the broker web site 2. When suggested price is accepted by either party, either party can enter the broker web site 2 and input the code number of answer and the accepted price and then click the button of accept, and the broker web site 2 will immediately modify the cost of providing the answer to the accepted price. If either party disclosed the information of identification or method of communication, both parties can negotiate the transaction through the broker web site 2 subject to the aforesaid procedure, or directly contact the opposite party without through the broker web site 2.

(VIII) Communicate With Each Other Indirectly Between the Inquirer and the Answer Provider:

When an inquirer 1 wishes to communicate with an anonymous member of potential answer provider 3 who had ever provided an answering service to the inquirer 1, the inquirer 1 can input the message to be discussed and the abstract of answer or code number of answer the anonymous member of potential answer provider 3 ever provided into the broker web site 2, and the broker web site 2 will soon transfer the message to the answer provider 3. On the contrary, a member of potential answer provider 3 can input the message of the code number of question of a particular question issued by a particular inquirer 1 ever contacted into the broker web site 2, letting the broker web site 2 to transfer the message to the inquirer 1. Either party can attach one's information of identification or the method of communication to the message inputting into the broker web site 2, and the opposite party can decide to make a direct contact without through the broker web site 2, or to make an indirect contact through the broker web site 2.

(IX) Disclose the Identification of Either Party or the Method of Communication”.

As indicated above, the inquirer 1 can disclose one's identification or the method of communication when issuing a question or message to make communication, inviting the members of potential answer provider 3 to make a direct contact (for example, in order to attract potential answer providers 3, the inquirer 1 can introduce oneself in the question issued to show the sincerity). On the contrary, the answer provider 3 can disclose one's identification or the method of communication when issuing the abstract of answer, answer, or message to make communication (for example, the answer provider 3 can introduce oneself or promote the sale to attract the inquirer 1 to buy the answer), enabling the inquirer 1 to make a direct contact. The broker web site 2 does not prohibiting the inquirer 1 or the answer provider 3 to disclose one's identification or the method of communication when issuing the answer or the information of the abstract of answer, answer, message to make communication, enabling both parties to make communication freely.

The broker web site 2 can earn money by means of receiving a commission of a particular percent on every transaction made, or charging the service on every transaction made subject to the volume of the question, answer, or abstract of answer. The broker web site 2 can also receive and charge advertisement on the web page.

In order to help understand the technical content of the electronic business of negotiating transactions between inquirer and answer provider, the invention is described hereinafter in detail by way of example, in which the inquirer 1 and the answer provider 3 are anonymous.

An individual computer manufacturer of country A (hereinafter called as Company A) accepts order from a famous company (hereinafter called as Company B) to manufacture super-thin notebook computers on the basis of OEM (original equipment manufacturer). Recently OEM profits dropped. In order to survive, Company A wishes to develop products at one's own trade name. However, it is necessary to obtain authorization of key technology owner when developing products at one's own trade name. In order not to let Company B know the intension of searching for key technology, Company A must keep the action in secret. In case Company B knows Company A's intention, Company B may cancel all orders from Company A.

(I) Open for the Registration of Potential Answer Providers in Different Technical Fields and Classify Registered Members of Potential Answer Provider Subject to Their Specialty:

Any computer manufacture can enter the broker web site 2 and then log in the respective field of specialty and input the respective e-mail address or method of communication. A foreign individual computer manufacturer (hereinafter called as Company C) entered the broker web site 2, inputted the respective e-mail address, and logged in the field of specialty of “computer product manufacturer.

(II) Accept Questions Issued by Inquirers:

Company A entered the broker web site 2, inputted the respective e-mail address and the question of “A notebook computer manufacturer of a particular country searches for microprocessor cooling technology for super-thin notebook computer and the related technical document its manufacturing authorization, any interest party please contact us”, and the click the field of specialty of “Computer product manufacturer”. Because the broker web site 2 does not disclose the information of identification of registered individual potential answer providers, the method of communication, and other data having nothing to do with the question and the answer, Company A cannot know who are the so-called “computer product manufacturers” registered in the broker web site 2. The broker 2 immediate gives a code number of question CM001 to the question issued by Company A, and informs Company A of the code number of question Cmool.

(III) Transfer the Questions Issued by Inquirers to Members of Potential Answer Provider:

Upon receipt of the question issued by Company A, the broker web site 2 transfers the question and the code number of question CM001 to various registered potential answer providers including Company C. Because the broker web site 2 does not disclose the identification of Company A to the potential answer providers, the method of communication, or other data having no concern with the question issued and Company A didn't disclose its identification and the method of communication when issuing the question, the potential answer providers do not know who issued the question.

(IV) Accept Information From the Members of Potential Answer Provider Regarding the Answer, the Abstract of Answer, the Cost of Providing the Answer:

Among the potential answer providers 3 who received the question, Company C showed much interest. Company C owned a microprocessor cooling technology, and wished to sell the technology. However, Company C has been suffering a financial problem, and does not wish the others to know its intention of selling their microprocessor cooling technology that may invite financing pressure. Therefore, Company C entered the broker web site 2, and inputted the code number of question CM001, the answer (the electronic file of the technical document of the technology concerned), the cost of providing the answer “US#30,000.-”, and the abstract of answer “We own the most advanced microprocessor heat sink technology and wish to sell the technology to you. The technology has been patented in two countries. A copy of the technical document of the technology is attached for reference”. Company C also makes a part of the technical document into an abstract of answer, and attaches it to the electronic file. The attached file of the abstract of answer is simply a small part of the technical document without key point. The broker web site 2 gave a particular code number of answer AM001, and informed Company of the code number of answer AM001 by e-mail.

(V) Transfer the Information of Abstract of Answer and Cost of Providing the Answer From the Members of Potential Answer Provider to the Inquirer:

Upon receipt of information about the code number of question, answer, abstract of answer, cost of providing the answer, etc. from Company C, the broker web site 2 held the answer at first, and then transferred the information of the code number of question CM001, code number of answer AM001, answer, abstract of answer, cost of providing the answer, etc. to Company A by e-mail. Because the broker web site 2 didn't disclose the identification of Company C and the method of communication or other data to Company A and, Company C didn't disclose its identification and the method of communication in the provided abstract of answer, Company A didn't know who was the answer provider.

(VI) Transfer the Answer to the Inquirer and Complete the Transaction:

(VII) Negotiate Transaction Under Anonymous Mode:

When viewed the abstract of answer from Company C, Company A thought worthy to buy and wished to lower the price. Therefore, Company A entered the broker web site 2, and inputted the code number of answer AM001 and expected price “US$20,000.-”. The broker web site 2 immediately transferred the message of Company A to Company C by e-mail. Upon receipt of the message, Company C agreed to accept the price, and then entered the broker web site 2, and clicked the button “accept” to accept Company A's counter price “US$20,000.-”. The broker web site 2 immediately transferred the code number of answer and the accepted price to Company A. Thereafter, Company A pay the amount of US$20,000.- to the broker web site 2 by credit card. Upon receipt of the payment, the broker web site 2 deducted the necessary tax and brokerage from the payment of US$20,000.-, and sent the money to Company C by check to complete the transaction.

(VIII) Communicate With Each Other Indirectly Between the Inquirer and the Answer Provider:

When obtained the technical document from Company C, Company A found a shortage of few pages of the document. Therefore, Company A entered the broker web site 2, and inputted the code number of answer AM001 and the message of “Few pages of the magnetization-protective procedure of your microprocessor heat sink technical document P-5A-1 were missed, please provide the supplement”. The broker web site 2 immediately transferred the communication message to Company C by e-mail. After received the communication message transferred by the broker web site 2, Company C entered the broker web site 2, and inputted the code number of question CM001 and the content of the missed pages of the technical document (in an electronic file), enabling the broker web site 2 to transfer the electronic file to Company C by e-mail.

(IX) Disclose the Identification of Either Party or the Method of Communication”.

Few years after development of super-thin notebook computers under self brand name based on the technology provided by Company C, Company A reduced OEM orders from Company B, and didn't care about Company B's reaction to the fact that Company A was selling super-thin notebook computers under its own brand name. Company appreciated the support of the technology provided by Company C, and wished to make further technical cooperation with Company C. Therefore, Company A entered the broker web site 2, and inputted the code number of answer AM001 of the previous transaction and the communication message of “This is AAA Computer Co., Ltd. ever purchased microprocessor heat sink technology from your company, and wishes to make further communication with your esteemed company. Our company's telephone number and e-mail address as follows . . . ”. The broker web site 2 immediately transferred the communication message to Company C by e-mail. Because Company C was free from financial crisis and didn't care about the disclosure of their technical authorization to Company A, Company C directly contacted Company A by phone after received the e-mail message from the broker web site 2.

A prototype of electronic business mode of using the Internet to negotiate transactions between an inquirer and an answer provider has been constructed with the features of the annexed drawings. The electronic business mode of using the Internet to negotiate transactions between an inquirer and an answer provider functions smoothly to provide all of the features discussed earlier.

What the invention claimed is:

1. An electronic business mode of establishing a broker web site in the Internet to negotiate transaction between an inquirer and an answer provider, comprising the steps of:
i) accepting registration of potential answer providers to become members of potential answer provider in different fields of specialty and classifying registered members of potential answer provider subject to their specialty;
ii) accepting questions issued by inquirers, where a party wishing to issue a question to ask for the answer can enter the broker web site and input one's e-mail address and the content of the question and click the field of specialty the inquirer though to be necessary to provide the answer to the question;
iii) transferring the question to the members of potential answer provider, where the broker web site transfers the question and a corresponding code number of question to the potential answer providers of the field of specialty clicked by the inquirer, asking the potential answer providers to answer the question;
iv) accepting information from the members of potential answer provider regarding the answer, the abstract of answer, the cost of providing the answer, where every answer provider who received the information of the question and the related code number of question from the broker web site can decide if to answer the question or not; any answer provider agrees to answer the question and wishes to sell the answer at a price can enter the broker web site and input the related code number of question, the answer, the abstract of answer, and the cost of providing the question; and,
v) transferring the information of the abstract of answer and cost of providing the answer from the members of potential answer provider to the inquirer, where the broker web site holds the answer at first, and then transfers the information of the code number of question, code number of answer, answer, abstract of answer, and cost of providing the answer to the inquirer, and then transfers the answer to the inquirer after the inquirer accepted the cost of providing the answer requested by the answer provider.

2. The electronic business mode of claim 1, wherein said answer providers and said inquirer can be individuals, corporations, organizations, or web sites.

3. The electronic business mode of claim 1, wherein in addition to the respective e-mail address, said answer providers and said inquirer can input personal web page, chat call ICQ, and other communication methods used in the Internet.

4. The electronic business mode of claim 1, wherein said answer provider or said inquirer can select to negotiate transaction under anonymous mode or with the real name, and when the transaction mode with the real name is selected by the potential answer provider, the potential answer provider must input the name and personal information, letting the personal information to be shown on the web page of the broker web site.

5. The electronic business mode of claim 1, wherein said answer provider or said inquirer can select to negotiate transaction under anonymous mode or with the real name, and when the anonymous transaction mode is selected by the potential, the potential answer provider does not need to input the name and personal information except the related filed of specialty, and the identification or method of communication of the potential answer provider will never be disclosed in the broker web site.

6. The electronic business mode of claim 1, wherein the broker web site gives a code number of question to every question issued by an inquirer and a code number of answer to every answer provided by a potential answer provider, and informs the respective inquirer or answer provider of the respective code number of question or code number of answer.

7. The electronic business mode of claim 6 wherein because one inquirer may issue a plurality of questions and one answer provider may provide a plurality of answers, different questions must be coded with different code number of question and different answers must be coded with different code number of answer for quick identification.

8. The electronic business mode of claim 6 wherein the way of informing the inquirer or answer provider of the code number of question or code number of answer includes web page indication, e-mail, web site on-line chat call, and other communication methods used in the Internet.

9. The electronic business mode of claim 1, wherein the inquirer can select to negotiate transaction with the answer provider who registered the transaction mode with the real name through the broker web site, or to directly contact the answer provider who registered the transaction mode with the real name without through the broker web site as desired.

10. The electronic business mode of claim 1, wherein when received a message, the broker web site writes the message into a message passenger and then sends the message; because any party receiving the message cannot trace back the delivery path of the message, no one can know the identification of the party who issued the message unless the party who issued the message agreed to disclose one's identification or method of communication.

11. The electronic business mode of claim 10 wherein said message passenger can be a web page of the broker web site, a personal web page, e-mail, chat call ICQ, or any of the communication methods used in the Internet.

12. The electronic business mode of claim 1 wherein said abstract of answer is provided by the answer provider in either of the following four ways or a combination of them:
1. The content of the answer without the key point;
2. A part of the answer without the key point;
3. Resume of the answer provider;
4. Any information that invites the inquirer to by the answer from the answer provider without revealing the key point of the answer.

13. The electronic business mode of claim 12 wherein the answer provider is allowed to input the code number of question, the abstract of answer, and the cost of providing the answer without providing the answer before establishment of the transaction.

14. The electronic business mode of claim 1 further comprising the step of transferring the answer to the inquirer and completing the transaction where the inquirer can enter the broker web site and input the code number of answer corresponding to the issued question and pay the money to the broker web site if the inquirer thought worthy to buy the answer, and the broker web site immediately transfer the answer to the inquirer and the payment to the answer provider upon receipt of the payment from the inquirer.

15. The electronic business mode of claim 14 wherein said code number of answer is a specific code for enabling the broker web site to correctly transfer the payment to the answer provider who provides the answer.

16. The electronic business mode of claim 14 wherein the payment is a down payment system, and the broker web site immediately transfers the answer to the inquirer and the down payment to the answer provider after receipt of the down payment from the inquirer, and then transfers the balance to the answer provider upon receipt of the same from the inquirer.

17. The electronic business mode of claiml4 wherein the answer provider does not input the answer into the broker web site, and the broker web site asks the answer provider to provide the answer for transferring to the inquirer after receipt of the payment/down payment from the inquirer.

18. The electronic business mode of claim 14 further comprising the step of deducting the tax from the payment when a transaction is done between the inquirer and the answer provider.

19. The electronic business mode of claim 1 further comprising the step of negotiating transaction under anonymous mode where both the inquirer and the answer provider selected anonymous transaction mode, the inquirer can enter the broker web site and input the message of the code number of answer and the expected price of obtaining the answer into the broker web site after received the message of the code number of question, the code number of answer, the abstract of answer and the cost of providing the answer transferred by the broker web site, and the broker web site immediately transfers the message inputted by the inquirer to the answer provider, and the answer provider can enter the broker web site and input the code number of answer and the expected cost of providing the answer upon receipt of the message transferred from the broker web site, and the broker web site will immediately transfer the message inputted by the answer provider to the inquirer.

21. The electronic business mode of claim 20 wherein ff either party disclosed the information of identification or method of communication, both parties can negotiate the transaction through the broker web site, or directly contact the opposite party without through the broker web site.

22. The electronic business mode of claim 1 further comprising the step of communicating with each other indirectly between the inquirer and the answer provider where when an inquirer wishes to communicate with an anonymous member of potential answer provider who had ever provided an answering service to the inquirer, the inquirer can input the message to be discussed and the abstract of answer or code number of answer the anonymous member of potential answer provider ever provided into the broker web site, and the broker web site will immediately transfer the message to the answer provider; on the contrary, a member of potential answer provider can input the message of the code number of question of a particular question issued by an inquirer ever contacted into the broker web site, letting the broker web site to transfer the message to the inquirer.

23. The electronic business mode of claim 1 further comprising the step of disclosing the identification of either party or the method of communication where the inquirer can disclose one's identification or the method of communication when issuing a question or message to make communication, inviting the members of potential answer provider to make a direct contact, and the answer provider can disclose one's identification or the method of communication when issuing the abstract of answer, answer, or message to make communication, enabling the inquirer to make a direct contact.
